(19) United States
(12) Patent Application Publication
(10) Pub. No.: US 2016/0235039 A1
(43) Pub. Date: Aug. 18, 2016

(54) PET LEASH AND COLLAR APPARATUS AND SYSTEM

(71) Applicant: Ron Beal, Austin, TX (US)

(72) Inventor: Ron Beal, Austin, TX (US)

(21) Appl. No.: 14/620,602

(22) Filed: Feb. 12, 2015

(51) Int. Cl. A01K 27/00

(52) U.S. Cl. CPC A01K 27/004; A01K 27/001; A01K 27/006

(57) ABSTRACT

The disclosure provides a dog collar and leash system. The system may comprise a collar structure. The collar structure may include an elongated flexible strap having a first end portion, a second end portion, and an elongated central portion extending from the first to the second end portion. A closing structure may establish engagement of the first and second end portions to define a closed loop.

The system may include a leash structure comprising a housing and a reel supported in the housing. A cord may be spooled on the reel. A spring may be mounted in the housing to provide a biasing force on the reel. A handle portion may be disposed at a free end of the cord.

The system may include a keeper structure comprising a first keeper element to retain the handle portion in fixed relationship with the collar structure when the cord is fully spooled.

### FIELD OF THE INVENTION

The present disclosure relates to pet leashes and collars, more specifically a system that provides containment of a pet and further provides functional elements that ease the experience of providing containment.

### BACKGROUND OF THE INVENTION

Pet leashes and collars are used for walking and controlling pets such as, for example, dogs. The disclosed subject matter provides a collar and leash system. The system may securely retain an animal within a vicinity such as, for example, in the vicinity of a user walking the animal. The system may further provide a handle and leash.

### BRIEF SUMMARY OF THE INVENTION

The disclosed subject matter provides a dog collar and leash system. The system may include a collar structure comprising an elongated flexible strap structure. The strap structure may have a first end portion and a second end portion. The second end portion may be disposed in spaced, opposed relationship to the first end portion. The strap structure may have an elongated central portion that may extend from the first end portion to the second end portion.

The collar structure may further comprise a closing structure configured to establish releasable joined engagement of the first end portion with the second end portion. When the first end portion and the second end portion are in joined engagement, the strap structure may define a closed loop.

The system may further comprise a leash structure supported by the collar structure. The leash structure may comprise a housing that may be affixed to the strap structure. The housing may include an outer wall, wherein the outer wall may comprise therein an aperture. The leash structure may further comprise a reel supported in the housing for rotation relative thereto. The leash structure may further comprise an elongated flexible cord spooled on the reel. The cord may have a fixed end secured to the reel and a free end opposite the fixed end. The cord may extend through the aperture for the free end to be located outside the housing. The cord may be unspooled from the reel by the free end being pulled away from the reel to cause rotation of the reel in a first direction. The cord may be re-spooled on the reel by the reel being rotated in a second direction to cause the cord intermediate the fixed end and free end to be taken up on the reel by winding, wherein the second direction may be opposite the first direction.

The housing may further comprise a spring mounted in the housing. The spring may be configured to provide a biasing force on the reel. The biasing force may urge the reel to rotate in the second direction so as to cause re-spooling of the cord in a fully spooled condition on the reel in the absence of opposing force at least equal to the biasing force provided by the spring.

The leash structure may further comprise a handle portion disposed at the free end of the cord. The handle portion may be configured to be manually grasped by a person for using the leash structure.

The system may further comprise a keeper structure. The keeper structure may comprise a first keeper element supported by the collar structure The first keeper element may be configured to retain the handle portion in fixed relationship with the collar structure when the cord occupies the fully spooled condition with the handle portion not grasped by a person.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 displays an embodiment of a dog collar and leash system.

FIG. 2 displays an embodiment of a partially disassembled dog collar and leash system.

FIG. 3A displays a portion of a flexible fabric material used for a strap structure in accordance with an embodiment.

FIG. 3B displays a portion of a strap structure closed on one end in accordance with an embodiment.

FIG. 4A displays two portions of a flexible fabric material used for a strap structure in accordance with an embodiment.

FIG. 4B displays a portion of a strap structure closed on both ends in accordance with an embodiment.

FIG. 5A displays a side view of the housing and cord positioned in the strap structure in accordance with an embodiment.

FIG. 5B displays a top view of the housing and cord positioned in the strap structure in accordance with an embodiment.

FIG. 6 displays an embodiment of a dog collar and leash system with elements of the dog collar and leash system embedded within the strap structure in accordance with one embodiment.

FIG. 7 displays an embodiment of housing pocket 136 within the strap structure.

FIG. 8 displays an embodiment of a light element pocket 138 within the strap structure.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

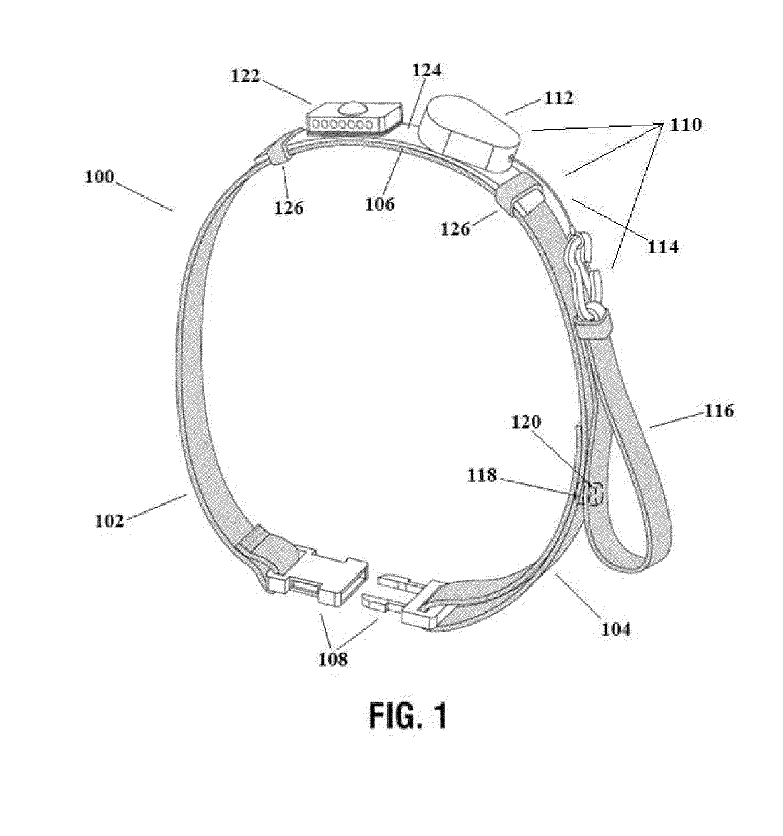

FIG. 1 displays an embodiment of a dog collar and leash system. The system may include a collar structure 100 comprising an elongated flexible strap structure. The strap structure may have a first end portion 102 and a second end portion 104. The second end portion 104 may be disposed in spaced, opposed relationship to the first end portion 102. The strap structure may have an elongated central portion 106 that may extend from the first end portion 102 to the second end portion 104.

The collar structure 100 may further comprise a closing structure 108 configured to establish releasable joined engagement of the first end portion 102 with the second end portion 104. When the first end portion 102 and the second end portion 104 are in joined engagement, the strap structure may define a closed loop.

The system may further comprise a leash structure 110 supported by the collar structure 100. The leash structure 110 may comprise a housing 112 that may be affixed to the strap structure. The housing may include an outer wall, wherein the outer wall may comprise therein an aperture. The leash structure 110 may further comprise a reel supported in the housing 112 for rotation relative thereto. The leash structure may further comprise an elongated flexible cord 114 spooled on the reel. The cord 114 may have a fixed end secured to the reel and a free end opposite the fixed end. The cord 114 may extend through the aperture for the free end to be located outside the housing. The cord 114 may be unspooled from the reel by the free end being pulled away from the reel to cause rotation of the reel in a first direction. The cord 114 may be re-spooled on the reel by the reel being rotated in a second direction to cause the cord 114 intermediate the fixed end and free end to be taken up on the reel by winding, wherein the second direction may be opposite the first direction. The housing 112 may further comprise a spring mounted in the housing 112. The spring may be configured to provide a biasing force on the reel. The biasing force may urge the reel to rotate in the second direction so as to cause re-spooling of the cord 114 in a fully spooled condition on the reel in the absence of opposing force at least equal to the biasing force provided by the spring.

The leash structure 110 may further comprise a handle portion 116 disposed at the free end of the cord 114. The handle portion 116 may be configured to be manually grasped by a person for using the leash structure 110.

The system 110 may further comprise a keeper structure. The keeper structure may comprise a first keeper element 118 supported by the collar structure 100 The first keeper element 118 may be configured to retain the handle portion 116 in fixed relationship with the collar structure 100 when the cord 114 occupies the fully spooled condition with the handle portion 116 not grasped by a person.

In embodiments, the keeper structure may comprise a second keeper element 120 associated with the handle portion 116. The second keeper element 120 may be configured for releasable engagement with the first keeper element 118 to retain the handle portion 116 in fixed relationship with the collar structure 100 when the cord 114 occupies the fully spooled condition with the handle portion 116 not grasped by a person.

In embodiments, the keeper structure may include first and second keeper elements 118,120 having magnetic properties. The second keeper element 120 may be configured for releasable magnetic engagement with the first keeper element 118 to retain the handle portion 116 in fixed relationship with the collar structure 100 when the cord occupies the fully spooled condition with the handle portion 116 not grasped by a person.

In embodiments, the keeper structure may comprise a second keeper element 120 associated with the handle structure 116. The first and second keeper elements 118,120 may be configured for releasable engagement to retain the handle portion 116 in fixed relationship with the collar structure 100 when the cord 114 occupies the fully spooled condition with the handle portion 116 not grasped by a person. The first and second keeper elements 118,120 may be configured to automatically establish engagement to retain the handle portion 116 in fixed relationship with the collar structure 100 when the cord returns from unspooled to the fully spooled condition.

In embodiments, the keeper structure may comprise first and second keeper elements 118,120 having magnetic properties. The second keeper element 120 may be configured for releasable magnetic engagement with the first keeper element 118 to retain the handle portion 116 in fixed relationship with the collar structure 100 when the cord 114 occupies the fully spooled condition with the handle portion 116 not grasped by a person.

In embodiments, the first and second keeper elements 118,120 may be configured to automatically establish engagement to retain the handle portion 116 in fixed relationship with the collar structure 100 when the cord 114 returns from unspooled to the fully spooled condition.

In embodiments, the system may include a light element 122. The light element 122 may comprise a power supply and LED in connection therewith.

In embodiments, the collar structure 100 may include a removable mounting structure. The removable mounting structure may comprise a portable base 124. In embodiments, the housing may be disposed on the portable base 124. In embodiments, at least one releasable fastener 126 may be configured for removably mounting the portable base 124 on the collar structure 100. In embodiments, the light element 122 may be disposed on the portable base 124. In embodiments, the at least one releasable fastener 126 may comprise a hook and loop fastening material.

In embodiments, the collar structure 100 may exclude a portable base 124. The components that may attach to the portable base 124 may attach directly to the leash by means such as but not limited to hook and loop fastening material.

In embodiments, the handle 116 may attach to the cord 114 by means of a clamp and loop system. In embodiments, the hook may be attached directly to the handle 116 or to the cord 114, whereas the clamp may be affixed to the component (handle 116 or cord 114) that does not comprise the loop. In further embodiments, the loop may exist in a swivel configuration.

In embodiments, the collar structure 100 may be comprised of a woven polymer. The warp and weft components of the weave may exist perpendicular and parallel to the direction of the length of the collar structure 100. In embodiments, the warp and weft components of the weave may exist at an angle other than a perpendicular angle to the direction of the length of the collar structure 100. The angle other than a perpendicular angle may allow for more flexibility of the collar structure 100. In embodiments, the weave may circumnavigate an interior space to create a flexible structure that may be affixed to itself by means such as, but not limited to threading, ultrasonic welding, etc. In embodiments, the collar structure 100 may be comprised of a knit polymer. In embodiments, the knit may circumnavigate an interior space to create a flexible structure that may be affixed to itself by means such as, but not limited to threading, ultrasonic welding, etc.

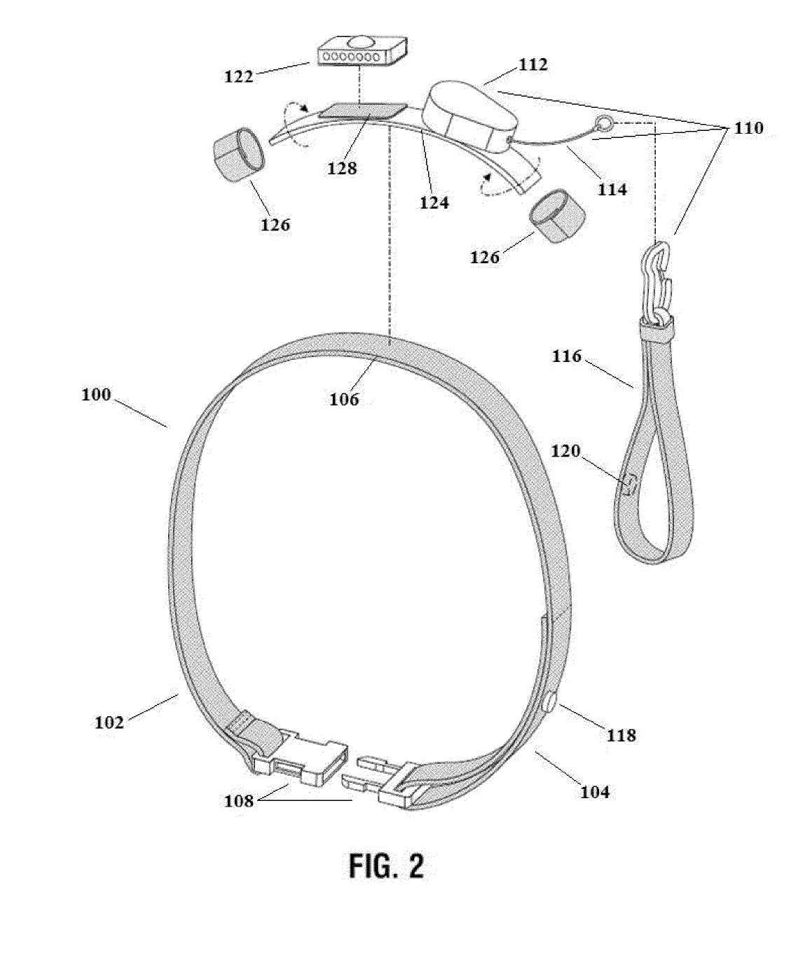

FIG. 2 displays an embodiment of a partially disassembled dog collar and leash system. In embodiments, a fastener 128 may be found on the portable base 124 to allow the light element 122 to be fastened to the portable base 124. In embodiments, the at least one releasable fasteners may envelope a portion of the collar structure 100 and the portable base 124.

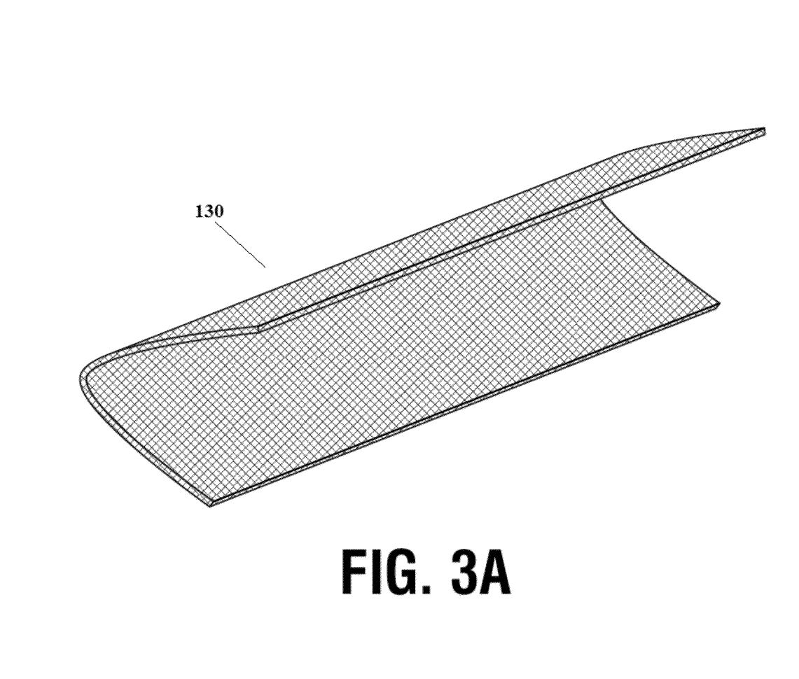

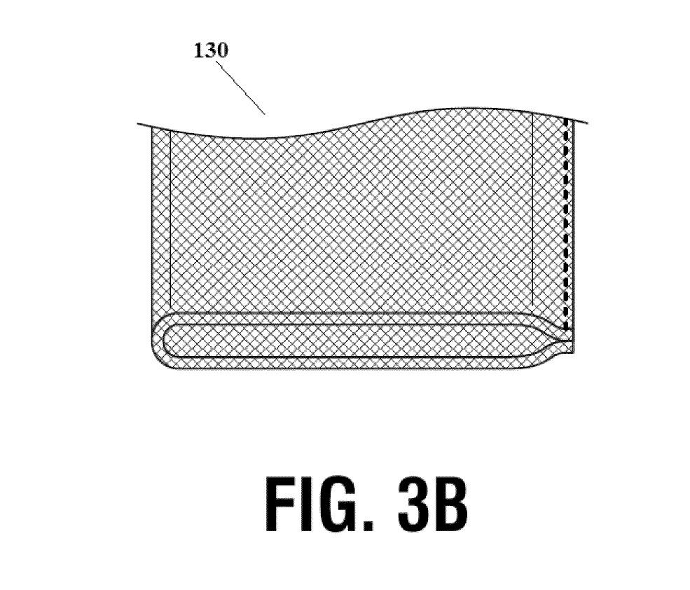

FIG. 3A displays a portion of a flexible fabric material 130 used for a strap structure in accordance with an embodiment. FIG. 3B displays a portion of a strap structure closed on one end in accordance with an embodiment. The flexible fabric material 130 may be folded over on itself and sealed at one lengthwise edge to make the strap structure usable for the collar structure 100.

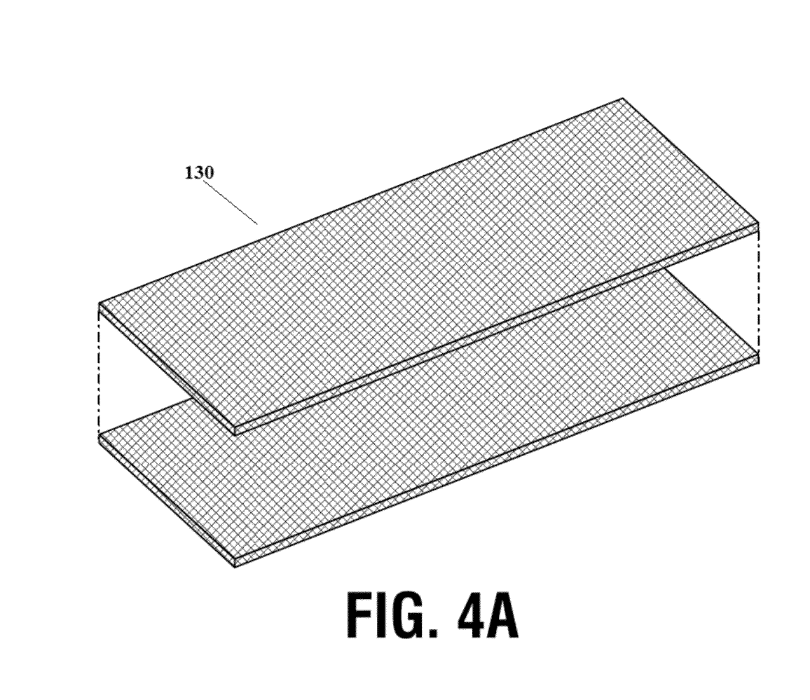

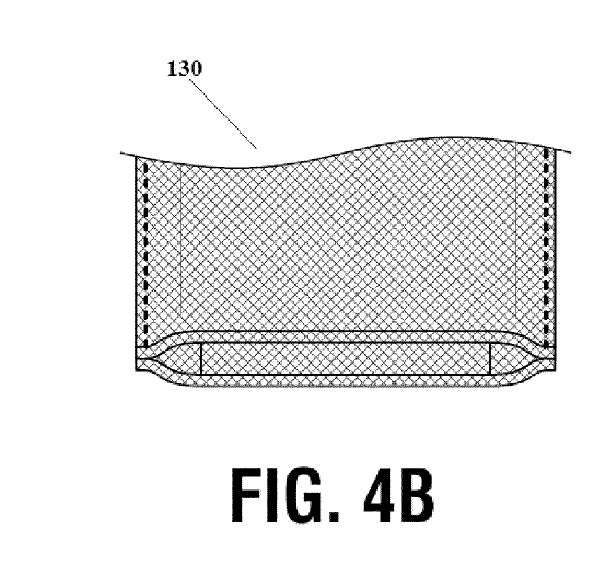

FIG. 4A displays two portions of a flexible fabric material 130 used for a strap structure in accordance with an embodiment. FIG. 4B displays a portion of a strap structure closed on both ends in accordance with an embodiment. Two pieces of flexible fabric material 130 may be put together and sealed on their lengthwise edges in order to make the strap structure used for the collar structure 100. At least one interior space may exist within the two pieces of flexible fabric material 130.

In embodiments, the handle portion 116 may comprise a loop formed of flexible fabric material 130.

In embodiments, the strap structure may consist essentially of an open mesh material. In embodiments, the strap structure may comprise an open mesh material and one or more other materials.

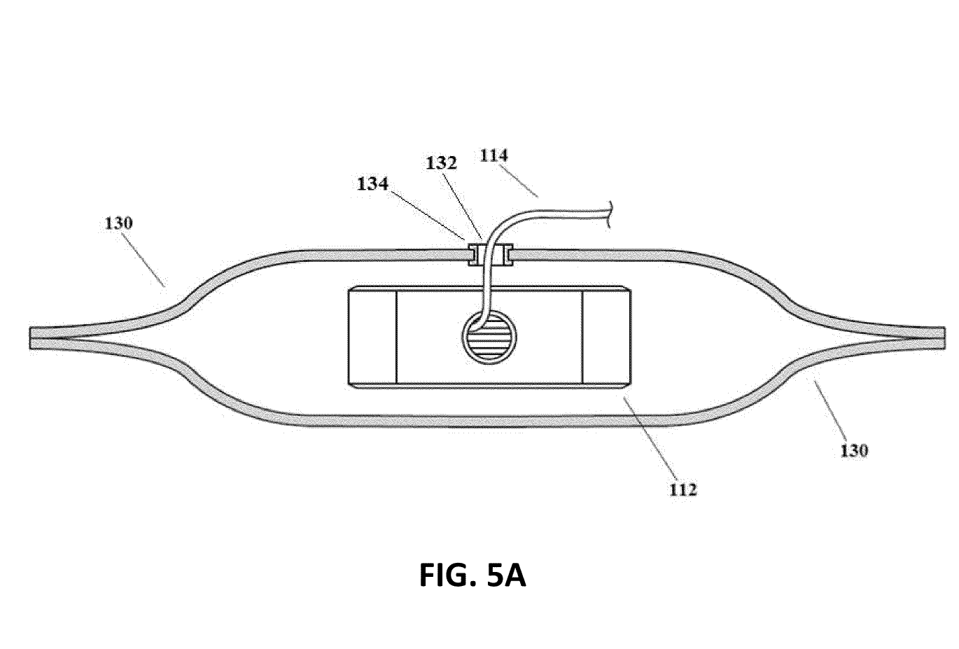

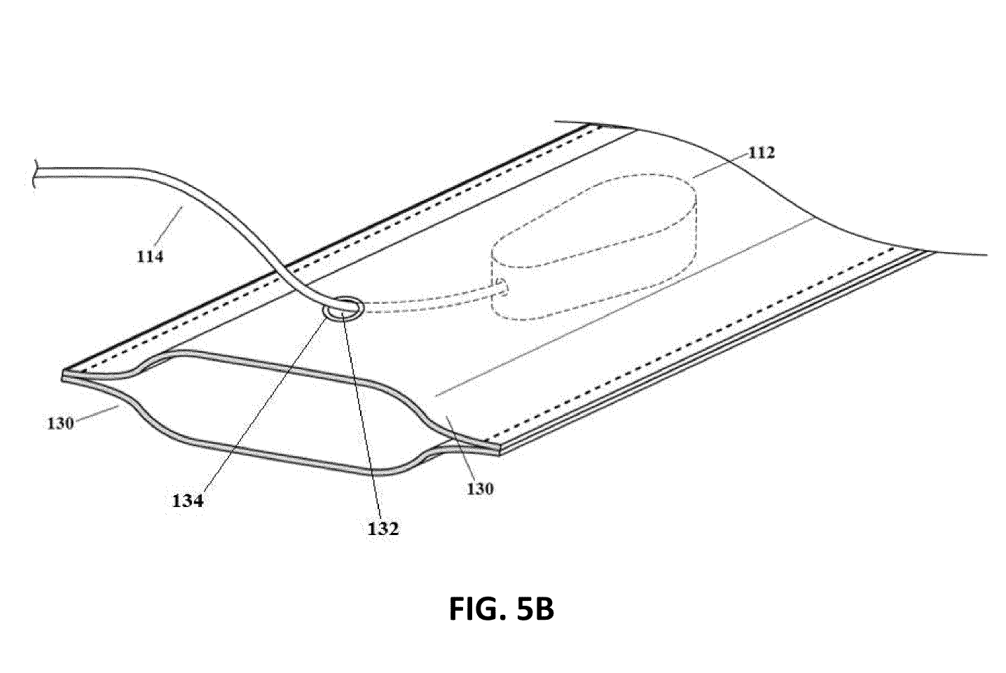

FIG. 5A displays a side view of the housing 112 and cord 114 positioned in the strap structure in accordance with an embodiment. Two portions of the flexible fabric material 130 sealed together on their side edges may provide a hollow interior. Elements of the system, such as a housing 112 may be held within the hollow interior. In embodiments, other elements of the system may be held within the hollow interior. The cord 114 may penetrate the orifice 132 in order that the cord 114 provide movement when being utilized. In embodiments, an orifice liner 134 may line the edge of the orifice 132. FIG. 5B displays a top view of the housing and cord positioned in the strap structure in accordance with an embodiment.

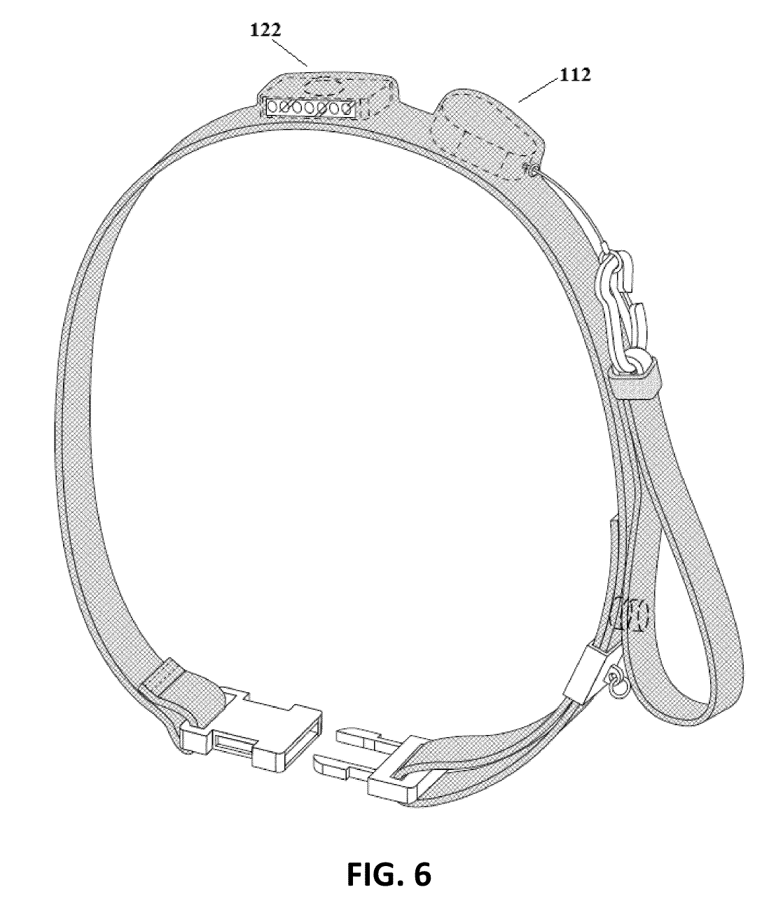

FIG. 6 displays an embodiment of a dog collar and leash system with elements of the dog collar and leash system embedded within the strap structure in accordance with one embodiment. The collar structure 100 may house one or more elements such as, but not limited to, the light element 122 or the housing 112. The elements may be partially or completely enveloped in the flexible fabric material 130. In embodiments, the flexible fabric material 130 may have transmissive properties in order to transmit light from the LED to the external environment.

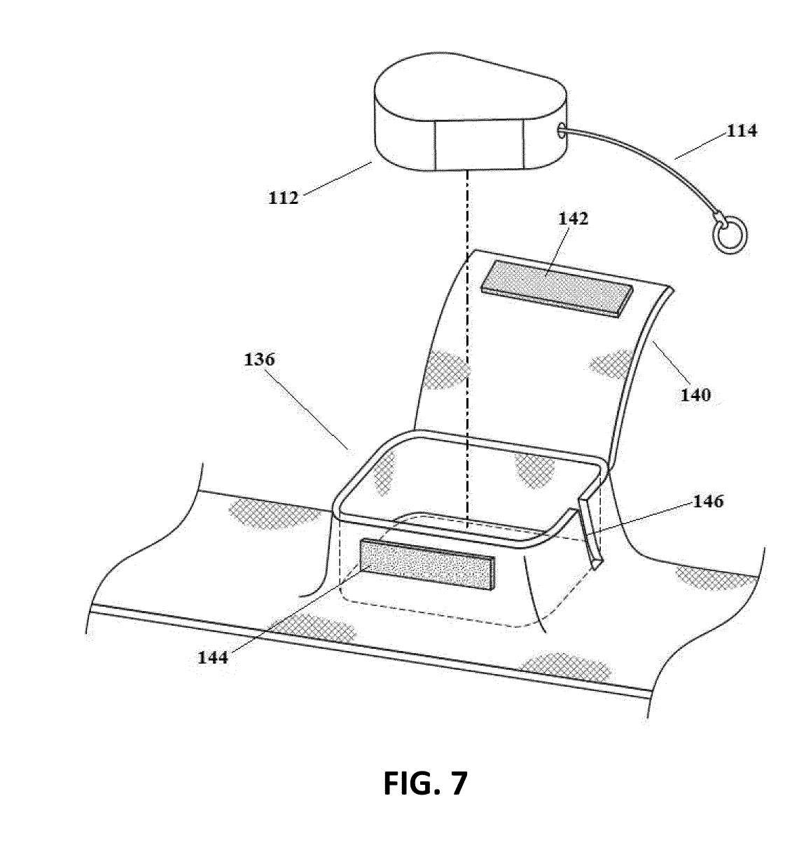

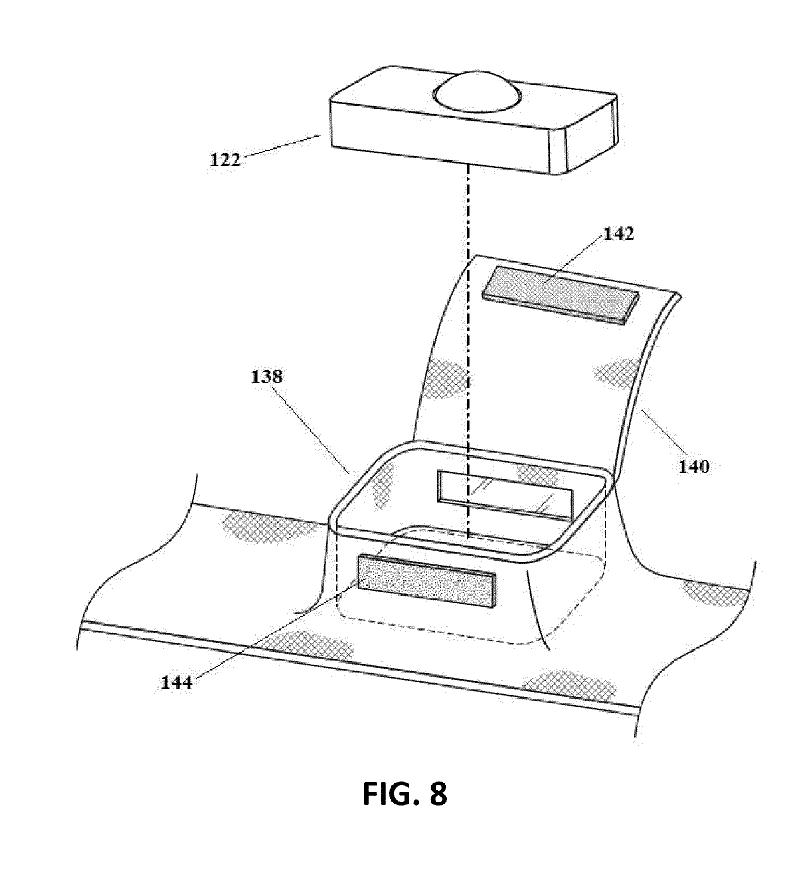

FIG. 7 displays an embodiment of housing pocket 136 within the strap structure. The housing pocket 136 may include a flap 140 to enclose an element such as, but not limited to, a housing 112, in the housing pocket 136. In embodiments, the housing pocket 136 and flap 140 may both comprise keeper elements 142,144. In embodiments, a section of the housing pocket 136 may comprise an orifice 146 to allow an element, such as a cord 114, to extend out of the housing pocket 136. FIG. 8 displays an embodiment of a light element pocket 138 within the strap structure. The light element pocket 138 may include a flap 140 to enclose an element such as, but not limited to, a light element 122, in the light element pocket 138. In embodiments, the light element pocket 138 may have a transmissive region configured to transmit light from the LED to the external environment. In embodiments, the housing pocket 136 and/or light element pocket 138 may house elements of the system other than a housing 112 or a light element 122. In embodiments, the light element pocket 138 and flap 140 may both comprise keeper elements 142,144.

In embodiments, the closing structure may comprise a first buckle member disposed at the first end portion 102 and a second buckle member disposed at the second end portion 104 in opposed relation to the first buckle member. The second buckle member may be configured for releasable joined engagement with the first buckle member. A closed loop may be defined upon the first buckle member being received in joined engagement with the second buckle member. The strap structure may be opened upon the first buckle member being released from joined engagement with the second buckle member.

What is claimed is:

1. A dog collar and leash system, the system comprising:
a collar structure comprising:
an elongated flexible strap structure, said strap structure having a first end portion, said strap structure having a second end portion disposed in spaced, opposed relationship to the first end portion, said strap structure having an elongated central portion extending from the first end portion to the second end portion;
closing structure configured to establish releasable joined engagement of the first end portion with the second end portion, wherein by joined engagement of the first end portion with the second end portion the strap structure defining a closed loop;
a leash structure supported by the collar structure, the leash structure comprising:
a housing affixed to the strap structure, the housing having an outer wall, the outer wall having therein an aperture;
a reel supported in the housing for rotation relative thereto;
an elongated flexible cord spooled on the reel, the cord having a fixed end secured to the reel, the cord having a free end opposite the fixed end, the cord extending through the aperture for the free end to be located outside the housing, the cord being unspooled from the reel by the free end being pulled away from the reel to cause rotation of the reel in a first direction, the cord being re-spooled on the reel by the reel being rotated in a second direction to cause the cord intermediate the fixed end and free end to be taken up on the reel by winding, the second direction being opposite the first direction;
a spring mounted in the housing, the spring configured to provide a biasing force on the reel, the biasing force urging the reel to rotate in the second direction so as to cause re-spooling of the cord in a fully spooled condition on the reel in the absence of opposing force at least equal to the biasing force provided by the spring;
a handle portion disposed at the free end, the handle portion configured to be manually grasped by a person for using the leash structure; and
keeper structure comprising:
a first keeper element supported by the collar structure, the first keeper element configured to retain the handle portion in fixed relationship with the collar structure when the cord occupies the fully spooled condition with the handle portion not grasped by a person.

2. A dog collar and leash system according to claim 1 and further comprising:
said keeper structure comprising:
a second keeper element associated with the handle portion, the second keeper element configured for releasable engagement with the first keeper element to retain the handle portion in fixed relationship with the collar structure when the cord occupies the fully spooled condition with the handle portion not grasped by a person for using the leash structure.

3. A dog collar and leash system according to claim 2 and further comprising:
said keeper structure comprising:
the first and second keeper elements having magnetic properties, the second keeper element configured for releasable magnetic engagement with the first keeper element to retain the handle portion in fixed relationship with the collar structure when the cord occupies the fully spooled condition with the handle portion not grasped by a person.

4. A dog collar and leash system according to claim 1 and further comprising:
said keeper structure comprising:
a second keeper element associated with the handle, the first and second keeper elements configured for releasable engagement to retain the handle portion in fixed relationship with the collar structure when the cord occupies the fully spooled condition with the handle portion not grasped by a person, the first and second keeper elements configured to automatically establish engagement to retain the handle portion in fixed relationship with the collar structure when the cord returns from unspooled to the fully spooled condition.

5. A dog collar and leash system according to claim 4 and further comprising:
said keeper structure comprising:
the first and second keeper elements having magnetic properties, the second keeper element configured for releasable magnetic engagement with the first keeper element to retain the handle portion in fixed relationship with the collar structure when the cord occupies the fully spooled condition with the handle portion not grasped by a person.

6. A dog collar and leash system according to claim 5 and further comprising:
the first and second keeper elements configured to automatically establish engagement to retain the handle portion in fixed relationship with the collar structure when the cord returns from unspooled to the fully spooled condition.

7. A dog collar and leash system according to claim 1 and further comprising:
said strap structure comprising a pocket, said housing disposed in said pocket.

8. A dog collar and leash system according to claim 1 and further comprising:
said strap structure comprising at least one light pocket configured to hold a light element, the light element comprising a power supply and LED in connection therewith, the at least one light pocket having a transmissive region configured to transmit light from the LED to the external environment.

9. A dog collar and leash system according to claim 1 and further comprising:
removable mounting structure comprising:
a portable base, said housing disposed on said portable base;
at least one releasable fastener configured for removably mounting the portable base on said collar structure.

10. A dog collar and leash system according to claim 9 and further comprising:
a light element disposed on said portable base, the light element comprising a power supply and LED in connection therewith.

11. A dog collar and leash system according to claim 9 and further comprising:
the at least one releasable fastener comprising hook and loop fastening material.

12. A dog collar and leash system according to claim 1 and further comprising:
a light element comprising a power supply and LED in connection therewith;
at least one releasable fastener configured for removably mounting the portable base on said collar structure.

13. A dog collar and leash system according to claim 1 and further comprising:
the handle portion comprising a loop formed of flexible fabric material.

14. A dog collar and leash system according to claim 1 and further comprising:
the strap structure consisting essentially of an open mesh material.

15. A dog collar and leash system according to claim 1 and further comprising:
the strap structure consisting of two layers of open mesh material configured to define therebetween at least one interior space.

16. A dog collar and leash system according to claim 15 and further comprising:
the two layers defined by a folded piece of the open mesh material, the folded open mesh material joined lengthwise along mating edges thereof.

17. A dog collar and leash system according to claim 1 and further comprising:
the closing structure comprising:
a first buckle member disposed at the first end portion;
a second buckle member disposed at the second end portion in opposed relation to the first buckle member, the second buckle member configured for releasable joined engagement with the first buckle member, the closed loop being defined upon the first buckle member being received in joined engagement with the second buckle member, the strap structure being opened upon the first buckle member being released from joined engagement with the second buckle member.
